(19) United States
(12) Patent Application Publication
(10) Pub. No.: US 2011/0168018 A1
(43) Pub. Date: Jul. 14, 2011

(54) HYBRID NANO SORBENT

(75) Inventors: Ali Mohamadalizadeh, Tehran (IR); Alimorad Rashidi, Tehran (IR); Jafar Towfighi Darian, Tehran (IR); Ali Mohajeri, Tehran (IR); Sorena Sattari, Tehran (IR); Mehrdad Manteghian, Tehran (IR)

(73) Assignee: RESEARCH INSTITUTE OF PETROLEUM INDUSTRY (RIPI), Tehran (IR)

(21) Appl. No.: 12/687,293

(22) Filed: Jan. 14, 2010

(51) Int. Cl. B01J 20/34; C01B 31/08; B01J 29/04; B01J 20/02; B01J 29/072; B01D 53/02

(52) U.S. Cl. 95/136; 502/416; 502/60; 502/406; 502/74; 95/139; 95/137; 977/700; 977/742; 977/750; 977/752

(57) ABSTRACT

The invention relates to a hybrid nano sorbent that is capable of reducing and/or removing acidic gases in a gas stream. The hybrid nano sorbent includes at least (i) a nano-structured carbonous material including at least one organic functional group, (ii) at least one metal from at least one of groups 2A, 6B, 7B, 9B or 10B of the periodic table of elements, or (iii) a combination of (i) and (ii). The method for reducing and/or removing the acidic gases in a stream is also described.

### TECHNICAL FIELD

The present invention relates to the application of carbon nano structures as sorbents of acidic compounds from gas streams and, more particularly, to application of different organic functional groups to modify the capacity of the sorbents. The invention also relates to the application of hybrids of the nano-structured materials with metals.

### BACKGROUND

The term “acid gases” is used to refer to natural gas or any other gaseous mixtures containing H₂S, SO₂, CO₂ and/or mercaptans. H₂S is a poisonous gas that harms the gas processing as well as transportations equipments. There have hence been developed, different sorbents for the separation of such species from gas streams.

Iron complexes with different chelating agents (e.g., nitrilo triacetic acid) having silica-alumina supporting material have been used as a medium sorbent. The sorption capacity of these sorbents is limited by the number and volume of the pores in the supporting material.

Other processes have used sponge iron as the sorbent. Such processes use iron oxide for separating H₂S. One major drawback of this type of process is that it is substantially impossible to regenerate iron oxide. Therefore, this type of process can only be used once to remove H₂₅ from a stream. Given that the lifetime of the sorbent is limited, the production and application of this type of processes are very high.

Another method that is used for this purpose constitutes the application of zinc oxide. The used sorbent, like that of the formed method, is deactivated after the passage of stoichiomeric amounts of H₂S. The method is hence applicable for removing low concentration of H₂S. Additionally, this process requires high temperatures.

Another sorbent that is used for separating H₂S includes 0-95% wt. clay, gypsum, alumina, and 0-60% wt. of hydrated iron oxide, which has been heated in 100-650° C. However, this sorbent is also capable of removing only low concentrations of H₂S.

Activated carbon is another sorbent used for separating of H₂S from gas and liquid streams. However, reaction rate and the amount of H₂S limit the capacity of this sorbent. Using ASTM method D-6646 testing protocol, it is observed that a typical coal-based activated carbon sorbent has a capability of removing 0.01 to 0.02 g/cc of H₂S.

U.S. Pat. No. 4,215,096 discloses a sorbent based on the impregnation of active carbon with caustic compounds such as sodium hydroxide or potassium hydroxide. Such caustic impregnated materials have an H₂₅ capacity of about 0.14 g/cc.

The catalytic carbon proposed in U.S. Pat. No. 5,494,869 and U.S. Pat. No. 5,356,849 addresses two of the disadvantages of the caustic impregnated activated carbon (CICA). First it does not exhibit the reduced combustion temperature that the CICA experiences and second, catalytic carbon does not lead to the reduction of the sorption of species, which do not react with the sorbent. Another advantage of catalytic carbon over CICA is that catalytic carbon can be regenerated using a water wash of a media, which generates a dilute sulfuric acid solution. The H₂S sorption capacity of catalytic carbon is, however, very low, in the range of 0.09 g/cc.

U.S. Patent Application Publication No. 2007/0000385 discloses a sorbent composed of activated carbon and metals like Mg and Ca that has a H₂₅ sorption capacity of 0.2-0.3 g/cc. This is because the oxidation reaction rate and capacity of pure metal oxides is relatively low due to their low pore volumes and surface areas; therefore, they cannot be used to eliminate toxic species of a stream. Finally, pure metal oxides do not have high sorption capacities of organic compounds that do not reacting with a support. The homogenous distribution of the metal oxide on the activated carbon matrix increases its capability for absorbing H₂S. The H₂S sorption capacity of these sorbents is 0.25 g/cc, which can be considered on an improvement over activated carbon, impregnated activated carbon and catalytic carbon. The sorbent, however, requires high pre-treatment temperatures. Additionally, due to its activated carbon wide pore size distribution, which is difficult to control, the repeatability of the experiments is very low.

Accordingly, there is a need for a sorbent that is capable of removing acidic contaminants from a stream that include properties such as high pore volumes, high thermal and electric conductivity, high surface area, and low coke formation activity. The sorbent should also have the capacity of surface chemical modifications and property that would allow users to control its pore dimension and pore distribution in mesoscale.

### SUMMARY OF THE INVENTION

Embodiments of present invention provide a hybrid nano-structured sorbent with high activity and rate and considerable sorption capacity, though the application of nano-structured carbonous material, which leads to outstanding improvements in the rate and capacity the sorption of acidic species from gaseous streams. Pore size of porous materials, like zeolites, is controlled and the size distribution is narrow, while activated carbon owns a wide distribution of pore sizes which is difficult to control in mass scale production. This result is due to the very low size of the pores and also due to the presence of bottle pores, which due to the high surface area increases the sorption while keeping diffuse phenomena low.

According to an embodiment of the present invention and as a result of the application of nano-structured carbonous species, the sorption rate is increased most probably due to the confinement effect and the resulting increase in the partial pressure of the gas. The mesoporouse structure of the used support also eliminates the mass-transfer limitations, which lead to the increased sorption rate.

According to an embodiment of the present invention, the nano-structured carbonous material of the present invention contains at least one or a combination of different organic functional groups and primary, secondary and/or tertiary amines, organic acid, ester, amide, imide, ether, and/or thioether groups.

According to an embodiment of the present invention, the nano-structured carbonous material incorporates at least organic functional groups from the group of primary, secondary and/or tertiary amines and/or organic acid groups.

According to an embodiment of the present invention, the nano-structured carbonous material of the present invention incorporates at least one of the functional groups from the group of primary, secondary and/or tertiary amines.

According to another embodiment of the present invention, the nano-structured carbonous material of the present invention is further combined with one or more metals from group 2A, 6B, 7B, 9B, and/or 10B of the periodic table of elements, to form a hybrid.

According to an embodiment of the present invention, the functionalized nano-structured support material (of the present invention) is further combined with one or more metals from group 2A, 6B, 7B, 9B, and/or 10B of the periodic table of elements to form a hybrid.

According to an embodiment of the present invention the functionalized nano-structured material of the present invention is further combined with the nano-structured clusters of at least one of the metals from group 2A, 6B, 7B, 9B and/or 10B of the periodic table of elements to yield a nano-structured hybrid.

According to an embodiment of the present, and contrary to slight worsening of the sorption characteristic of the nano-hybrid sorbent of the present invention, the nano-structured carbonous material of the present invention can be used without prior purification, while they still contain material such as WO₃ and/or ZrO₂ and/or ZnO and/or MgO and/or Mesoporous Crystalline Material (MCM)-41, and/or MCM-22 and/or TiO₂, which are commonly used as support material for growing nano-structure carbonous material.

According to an embodiment of the present invention, the nano-structured carbonous material of the present invention may be purified from compounds such as WO₃ and/or ZrO₂ and/or ZnO and/or MgO and/or MCM-41, and/or MCM-48 and/or MCM-22 and/or TiO₂ prior to use in the preparation of the hybrid sorbent of the present invention.

According to an embodiment of the present invention, purification of the carbonous support material includes functionalizing and/or combining a produced nano-structured carbonous material with nano-clusters of one or more of groups 2A, 6B, 7B, 9B, and/or 10B of the periodic table of elements to provide a hybrid sorbent of the present invention. This nano-sorbent has various applications in oil, gas, chemistry, petrochemical, wood, paper, and steel industries.

The sorbent of the present invention can be used for the elimination of acidic compounds ranging from H₂S, CO₂ and mercaptans, alkyl sulfides, dimethyl sulfide, methyl mercaptans to SO₂ from different hydrocarbon gas streams like natural gas, stack gas, flare gas, and tail gas.

The nano-hybrid sorbent of the present invention can remove acidic compounds in the concentration range of from about 10 to about 8000 ppm under atmospheric pressure and room temperature physically and without any chemical reactions.

The nano-hybrid sorbent of the present invention functions in the temperature range of from about 263 K to about 423 K and under from about atmospheric pressure to about 10 bar of pressure in the absence of O₂ or any other oxidizing gases without chemically reacting with the acidic gasses. Additionally, the nano-hybrid sorbent of the present invention can be further regenerated in a temperature range of from about 473 K to about 573 K under from about atmospheric pressure and substantially in the absence of O₂ or any other oxidizing gases.

The acidic species are released having no chemical reaction during the sorbent regeneration step are then eliminated and the sorbent is returned to the reactor.

### BRIEF DESCRIPTION OF THE DRAWINGS

FIG. 1 is a photo of Metal (W) sulfide nano structure formed in the nano structured carbonous support (have MWCNT).

### DETAILED DESCRIPTION

Nano-structured carbonous materials of the present invention can include one or more of single, double, and/or multiple wall carbon nanotubes, carbon nanofibers, nanohorns, and nano porous carbon. These nano-structured carbonous materials can by themselves (i.e., purely) or together with a support material. The These nano-structured carbonous materials can preferably be functionalized with organic functional groups and/or be combined with one or more metal nano-clusters from group 2A, 6B, 7B, 9B and/or 10B of the periodic table of elements to yield a nano-hybrid for the sorption of acidic species (e.g., H₂S, CO₂, SO₂, and/or mercaptans) from hydrocarbon gas streams.

The nano-structured carbon material can include at least one of single-wall carbon nano tubes (SWCNTs) with average diameters of 1-4 nm, pore volume of from about 0.2 cc/g to about 1.2 cc/g, surface area of from about 500 m²/g to about 1500 m²/g and tube of from about 1 μm to about 100 μm, double-wall carbon nano tubes (DWCNTS) with average diameters of from about 2 nm to about 5 nm, pore volumes of from about 0.2 cc/g to about 1.2 cc/g, surface area of from about 400 m²/g to about 700 m²/g and tube lengths of from about 1 μm to about 100 μm, multi-wall carbon nano tubes (MWCNTS) with average diameters of from about 5 nm to about 80 nm, pore volumes of from about 0.2 cc/g to about 1.2 cc/g, surface areas of from about 100 m²/g to about 500 m²/g and tube lengths of from about 1 μm to about 100 μm, single wall carbon nano horns (SWNHS) with pore volume of from about 0.3 cm³/g to about 0.5 cm³/g, pore diameters of from about 30 nm to about 50 nm and/or nano porous carbon with pore diameters of from about 4 nm to about 5 nm, pore volume of from about 0.9 cc/g to about 1.1 cc/g, surface areas of from about 800 m²/g to about 900 m²/g either purely or as produced over the support material, and, for example, in pure form which may be modified by being functionalized to contain organic functional groups of primary, and/or secondary and/or tertiary amine, acid ester, imide, ether, and/or thioether and/or other organic functional groups and, for example, in combination with nano-clusters of at least one of groups 2A, 6B, 7B, 9B and/or 10B of the periodic table of elements, for example, metal nano clusters may be used.

According to some embodiments of the present invention, SWCNTS with tube diameters of from about 1 nm to about 4 nm, pore volumes of from about 0.2 cc/g to about 1.2 cc/g, surface areas of from about 500 m²/g to about 1500 m²/g and tube lengths of from about 1 μm to about 100 μm with both end of the tubes having been opened, may be used as support material for the nano-hybrid sorbent of the present invention.

The nanostructured carbonous material is used without and/or preferably after prior-to-use purification and/or without and/or preferably after functionalization and/or without and/or preferably as combined with metal clusters, preferably nano metal clusters of at least one of the metals of 2A, 6B, 7B, 9B and/or 10B groups of the periodic table.

The organic functional groups to be grafted on the nano-structured carbonous material of the present invention can include, but is not limited to, at least one of primary, and/or secondary and/or tertiary amine groups, acid, ester, amide, imide, ether, thioether.

The metals clusters, and for example nano clusters, can include one or more groups clusters, such as nano clusters of W, Mn, Co, Cr, Mo, Mg, and/or Ni.

The organic functional groups may include primary and/or secondary and/or tertiary amine and/or amide groups alone or together with clusters, such as nano clusters of, for example, at least W, Co, Mo, and/or Ni.

The organic functional group may include amine groups, and the clusters may include metal clusters, such as W clusters and/or W nano clusters.

As mentioned above, the carbonous nano material can be used in pure form or optionally, but not necessarily to reduce the sorbent preparation time and cost can be grown over WO₃ and/or ZrO₂ and/or MgO and/or MCM-41 and/or MCM-48 and/or MCM-22 and/or TiO₂.

According to an embodiment of the present invention, in the case of using impure nano-structured carbonous material at the weight percent of WO₃ and/or ZrO₂ and/or ZnO and/or MgO and/or MCM-41 and/or MCM-48 and/or MCM-22 and/or TiO₂ in a hybrid sorbent may be less than 50% wt. of the total weight of the hybrid sorbent, for example, an amount of 0% wt. The weight percent of the organic functional groups in the total weight of the hybrid sorbent can range from about 0.1 to about 3% wt. and that of the metal, and particularly nano-metal, clusters ranges from about 0.1% to about 9% wt.

The total weight percent of the mentioned support impurities, according to one embodiment of the present invention may be less than 25% wt. of the total weight of the hybrid sorbent.

The weight percent of the organic functional groups may be in the range of from about 0.1 to about 5% wt. and, for example, in the range of from about 0.1 to about 5% wt, and that of the metal clusters, for example, nano clusters, to be in the range of from about 0.1 to about 5% wt.

As mentioned above, an embodiment of the present invention may comprise about 0% wt. of the support material, (i.e., pure nano-structured carbonous material comprising from about 0.1 to about 10% wt. of the organic functional groups and from about 0.1 to about 3% wt. of the clusters, such as nano clusters of the aforementioned).

The nano carbonous material whether in a purified form or with a support material is refluxed with a H₂SO₄/HNO₃ solution filtered, washed with deionized water, and then dried to contain organic acid groups. The resulting product can then be reacted with urea to form amide groups thereon, which can be converted to a desired amine groups using sodium perchlorate solutions.

An H₂O₂/Fe₂(SO₄)₃ solution can be used to form OH groups on the nano carbonous material, which can be converted to ether groups by applying different alkyl chlorides and sodium hydroxide of desire to form ether groups.

Other methods of functionalization can also be used to create the desired functional groups. Additionally, the stoichiometry of the reaction solutions can be altered to create different desired functional groups. Furthermore, the reactions can be stopped at any stage utilize the grafted/created functional groups on the support material.

The clusters, such as the nano clusters of the aforementioned metals can be deposited on the support material using different conventional methods such as chemical vapor deposition, micro-emulsion, impregnation, hydrothermal deposition, and sol gel. Micro-emulsion method is preferred given that it can lead to a formation of better metal nano clusters.

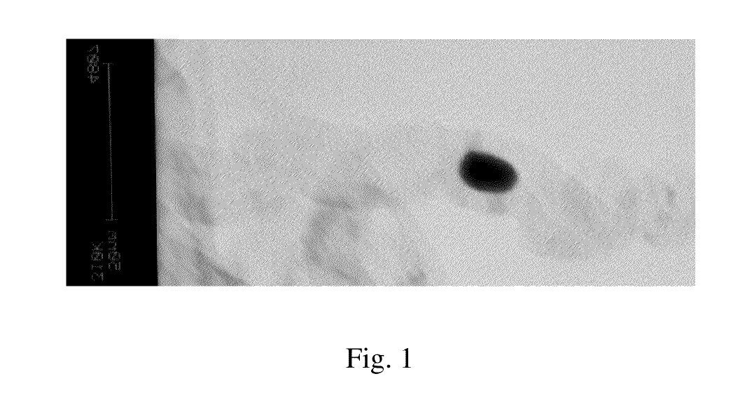

When utilizing the micro-emulsion to form metal clusters on the support material, water soluble salts of groups 2A, 6B, 7B, 9B and/or 10B of the periodic table of elements are used to form the metal clusters on the support material. Such salts can include, for example, water soluble salts from the group of ammonium meta tungstate, tungsten oxide, and/or ammonium para tungstate. In one example, ammonium meta tungstate is used to form the metal clusters, such as metal nano clusters (FIG. 1) on the support material.

In one example, preferred sorption characteristics were observed when pure nano structured carbonous materials were functionalized to contain amine groups and W nano clusters.

The nano structured hybrid sorbent of the present invention can be used for the sorption of acidic compounds like H₂S, CO₂, mercaptens and/or SO₂ from different hydrocarbon gas streams containing such compounds in the concentration range of from about 10 to about 8000 ppm. The sorption process can be performed in a temperature range of from about 263 to about 423 K, in the absence of O₂ or any other oxidizing gas and in the pressure range of about atmospheric pressure to about 10 bars without any chemical reactions taking place (i.e., through physical sorption, which can be reversed during the sorbent regeneration stage in a temperature range of from about 473 to about 573 K, and a pressure of about atmospheric pressure, and in the absence of oxidizing gases).

The sorption capacity of the sorbent of the present invention can reach about 0.4 g/cc or higher.

FIG. 1 is a photo of Metal (W) sulfide nano structure formed in the nano structured carbonous support (have MWCNT).

The general method for preparing the hybrid nano structured sorbent material of the present invention is to prepare a nano-structured carbonous material. In one example, the nano-structured carbonous material can be prepared through chemical vapor deposition (CVD) of hydrocarbons, such as acetylene, ethylene or methane in a temperature range of from about 500 to about 800° C. for about 10 to about 60 minutes over WO₃, and/or ZrO₂ and/or ZnO and/or MgO and/or MCM-41 and/or MCM-48 and/or MCM-22 and/or TiO₂. The resulting product can be used with or without further purification and preferably after purification from the support material.

The nano-support metal hybrid can be prepared through any metal deposition methods, for example one leading to the deposition of metal nano clusters and preferably through one of the following methods.

In a first method, a soluble metal salt is dissolved in the solvent which can include one or more of ethanol, methanol, and/or 2-propanal. The solution can then be poured over the nano-structured carbonous material which may or may not be purified. The mixture is then dried from about 2 to about 4 hours in a temperature of from about 80 to about 110° C. and then calcinated in two steps to about 500° C. with a ramp of from about 2 to about 10° C./min in an inert atmosphere and then reduced using H₂ gas. The product can be optionally directly used as a sorbent in the above-mentioned operating conditions.

In a second method, cyclohexane and aerosol odor terminator (AOT) are first mixed in a 1:1 ration, wherein the former can serve as the oil phase and the latter can serve as a surfactant. A mixture of desired metal salts, such as ammonium meta tungstate and 2M ammonia can then be prepared to form an aqueous phase. The aqueous phase, surfactant, and oil phase mixture can than be mixed and the carbon nano material can be dispersed in the resulting phase. The resulting mixture can then be centrifuged and filtered for about 2 hours before being calcinated in two steps at a temperature of about 500° C. with a ramp of from about 2 to about 10° C./min under inert atmosphere, and then reduced using H₂.

In a third method, a carbonous nano structure can first be washed with from about 15 to about 40% wt. solutions of nitric acid from about 10 to about 24 hours and then filtered to obtain a nano structures with both ends open. The nano structures can then be filtered and dried in a temperature of from about 80 to about 110° C. One of the two methods described above can then be used to deposit the metal clusters and preferably metal nano clusters on the carbonous nano structure.

To create a desired organic functional group on the product of the previous step or on the untreated pure or impure carbonous nano material, the support material is refluxed with a sulfuric/nitric acid mixture, filtered and washed with deionized water to include carboxylic groups. This product can either used to create the desired organic functional group or can further be reacted with urea to convert all or a portion of the acid groups to amide groups. The resulting product can then be further reacted with a sodium perchlorate solution to convert all or a portion of the amide groups to amine groups.

To create OH groups on a support, aqueous H₂O₂ and iron sulfate solutions with H₂O₂: iron sulfate ratios of 20:0.1, and preferably 10:1 are used. The product of H₂O₂ and iron sulfate creates the desired OH groups. Alternatively, this product can be further treated with different alkyl chlorides to change all or a portion of the OH groups to ether groups.

The hybrid nano sorbent can be used under conventional sorption conditions in the absence of oxidizing gases. A sample set of operating conditions suitable for the application of the sorbent is in a steal reactor, where the feed contains from about 10 to about 8000 ppm of H₂S, CO₂, mercapthans and/or SO₂ with a flow rate of from about 500 to about 1200 ml/min, in a temperature range of from about 263 to about 423K under about atmospheric pressure to about 10 bars. For safety reasons, H₂S or mercaptans are passed through a NaOH or iron chelate solution.

The analyses of the inlet and outlet streams are performed with a gas chromatographer equipped with TCD or SCD detector or through the method of UOP163.

The sorbent characteristics were studied using XRD, Raman, SEM, ASAP, BET and HRTEM.

### EXAMPLES

The following examples are not meant to restrict the subject matter of the invention and are rather for further clarification.

### Example 1

4 g of MWCNT was used for the separation of H₂S from gas streams containing 4500 ppm of H₂S and the rest being composed of methane and helium. The flow rate was about 650 ml/min and under atmospheric pressure and a temperature of 65° C. After 5 hours the outlet contained 400 ppm of H₂S.

### Example 2

2 g of MCM-41 together with 4 g of MWCNT were dispersed in a water/ethanol solution and after ultrasonic treatment and filtration, were dried for approximately 3 hours at a temperature of about 110° C. The sorbent was used to treat a sample containing 5500 ppm of H₂S together with methane and helium. The flow rate of the sample was approximately 650 ml/min under atmospheric pressure and a temperature of approximately 65° C. The output contained 600 ppm of H₂S after 4 hours.

### Example 3

A 5% wt. solution of Co and W (with a mole ratio of 2:1) in 2-propanol was deposited on 4 g of MCM-41 through the wetness incipient impregnation and then dried for approximately 2 hours. A calcination step was performed which started at a temperature of 550° C. with approximately 5° C./min ramp and was continued for approximately 2 hours before reducing the sample with H₂. A chemical vapor deposition (CVD) technique was then used to deposit carbon nano tubes (CNT) over the sample using acetylene as the carbon source in a temperature of from about 400 to about 600° C. for approximately 45 minutes.

The hybrid nano structure was then used as a sorbent for removing acid gases from methane, helium, and 7000 ppm of H₂S. The flow rate was approximately 700 ml/min, under atmospheric pressure and a temperature of about 65° C. The outlet contained approximately 500 ppm of H₂S after 5 hours.

### Example 4

4 g of MWCNT with a mesh size of 100-200 was sonicated in a 36N sulfuric acid solution and 15.8N nitric acid with a ratio of 60:40 for approximately 3 hours. The solution was then cooled to room temperature before being washed with distilled water and then dried for approximately 6 hours in at a temperature of 120° C.10 g of urea was added for each 0.5 g of MWCNT and the sample was heated to a temperature of approximately 150° C. for 15 minutes. Distilled water was added and then centrifuged. The extraction was performed using sodium perchlorate and the resulting product was washed with distilled water and then dried. The resulting sample was used as a sorbent for the removal of acid gases from a methane, helium, and 7000 ppm of H₂S. The flow rate was approximately 620 ml/min under atmospheric pressure and temperature of about 65° C. The outlet contained approximately 100 ppm of H₂S after 8 hours.

### Example 5

Tungsten nano clusters were deposited on MWCNT support using the wetness incipient impregnation by adding approximately 0.27 g of ammonium meta tungstate to 7 g of 1:1 distilled water, ethanol mixture. The resulting solution was poured on 4 g of MWCNT with a mesh size of from about 80 to about 100. The solution was then dried for 2 hours in a temperature of approximately 110° C. and then calcinated in two steps. The first step of calcination started at room temperature with a slope temperature increase of about 2° C./min for half an hour until the temperature reached approximately 200° C. in the presence of O₂ and He. The temperature was then increased to approximately 450° C. at a rate of approximately 2° C./min The sample was kept at 450° C. for half an hour. At 350° C. the oxygen inlet was cut and the final sample was reduced using H₂ gas.

The sorbent was used for removing acid gases from a sample of Helium, methane, and 6500 ppm of H₂S. The flow rate of the sample was 620 ml/min at a temperature of about 65° C. and atmospheric pressure for 12 hours. The outlet contained approximately 100 ppm of H₂S.

### Example 6

Zinc nitrate was used as the Zn source and was deposited on MWCNT. 0.58 of zinc nitrate was dissolved in 7 g of distilled water and the resulting solution was poured over 4 g of MWCNT with a mesh of from about 80 to about 100.

The resulting solution was dried for 2 hours at a temperature of about 110° C. Two-step calcination followed starting from room temperature to 200° C. with a ramp of about 2° C./min for half an hour. The solution was then reduced using H₂ gas in the presence of O₂. The temperature was then increased to 450° C. with the same ramp for half an hour. The sample included helium and methane mixture containing 3500 ppm of H₂S with a flow rate of approximately 620 ml/min at a temperature of about 65° C. and atmospheric pressure for 3 hours. The outlet contained approximately 500 ppm of H₂S.

### Example 7

Ammonium heptamolybdate was used for depositing Mo on MWCNT. 0.37 g of ammonium heptamolybdate was dissolved in 7 g of a 1:1 distilled water-ethanol solution and 4 g of MWCNT with a mesh size of from about 80 to about 100 was added to the solution. The solution was then heated at a temperature of about 110° C. for two hours before two step calcination as described in Example 6. The sorbent was tested according to the procedure used in example 6 and after 7 hours the outlet contained approximately 1300 ppm of H₂S.

### Example 8

1 g of nickel nitrate was used to be deposited on a MWCNT support, and the sorbent was tested according to the procedure described in Example 6. After 5 hours, the outlet contained approximately 500 ppm of H₂S.

### Example 9

4 g of MWCNT was washed with 30% wt. nitric acid twice and then filtered and dried. W was then deposited thereon according to Example 5. The sorbent was used for the removal of H₂S from a sample of helium, methane, and 7000 ppm of H₂S. The sample had a flow rate of approximately 620 ml/min at a temperature of about 20° C. and at atmospheric pressure. The outlet contained approximately 50 ppm of H₂S after 12 hours. Then sorbent was treated at 200° C. for 2 hours. The gas chromatography (GC) analysis of the outlet only showed the presence of H₂S. Sorption test was carried on the nano sorbent again and similar to the previous test, 50 ppm of H₂S was found in outlet stream. Increasing the pressure to 8 bar was found to increase the H₂S sorption by five times. The sulfur contents were determined through high temperature measurements of sulfur content using a LECO CS600 analyzer equipped with an IR detector through UOP 865 method. It is noteworthy that analyses revealed no sulfur particles, indicating the physical nature of the phenomena at the reactor.

### Example 10

4 g of SWCNT with both ends opened contained W in an amount of 3% wt. and was functionalized. The procedure in Example 4 was used for the sorption of H₂₅ from a He/methane mixture containing 8000 ppm of H₂S. The sample included a flow rate of approximately 620 ml/min at room temperature and under atmospheric pressure for 13 hour. The outlet contained 50 ppm of H₂S while high temperature measurement of sulfur content using IR detector and UOP864 showed no solid sulfur particle formation.

The table below summarizes the sorption capacities of different inventions:

| | capacity |
|---|---|
| invention | adsorption g/cc |
| (U.S. Pat. No. 4,215,096 - Sinha et al.) caustic- | 0.14 |
| impregnated | |
| (U.S. Pat. No. 5,356,849 - Matviya et al.) catalytic | 0.09 |
| carbon | |
| (U.S. Pat. No. 6,858,192 - Graham et al.) | 0.25 |
| (U.S. 2007/0000385 - Stouffer) | 0.2-0.3 |
| In present invention with hybrid of functionalized | 0.4< |
| SWCNTs and tungsten | |

1. A hybrid nano sorbent capable of reducing acidic gases, the hybrid nano sorbent comprising at least one of.
A—at least a nano-structured carbonous material including at least one organic functional group or
B—at least one metal from at least one of groups 2A, 6B, 7B, 9B or 10B of the periodic table of elements.

2. The hybrid nano sorbent of claim 1, wherein the nano-structured carbonous material comprises at leased one of single-wall carbon nano tubes, double-wall carbon nano tubes, multiple-wall carbon nano tubes, carbon nano fibers, carbon nano fibers, single-wall carbon nanohorns, nano porous carbon, or any combination thereof.

3. The hybrid nano sorbent of claim 1, wherein the nano-structured carbonous material includes a first open end and a second open end.

4. The hybrid nano sorbent of claim 1, wherein the nano-structured carbonous material is an impure nano-structured carbonous material and is grown over at least one of WO₃, ZrO₂, ZnO, MgO, MCM-41, MCM-48, MCM-22, TiO₂, or any combination thereof.

5. The hybrid nano sorbent of claim 1, wherein the nano-structured carbonous material is a pure single-wall carbon nanotube.

6. The hybrid nano sorbent of claim 1 in which the nano-structured carbonous material contains at least one functional group comprises at least one of OH, Carboxylic, primary, secondary and/or tertiary amines, acids, esters, amides, imides, ethers, thioethers, or any combination thererof.

7. The hybrid nano sorbent of claim 1, further comprising a nano structured carbonous material that includes at least one functional group comprising at least one of amine or amide functional group.

8. The hybrid nano sorbent of claim 7, wherein the nano-structured carbonous material comprises an amine group.

9. The hybrid nano sorbent of claim 1, wherein the metal from at least one of groups 2A, 6B, 7B, 9B, or 10B of the periodic table of elements is a metal nano cluster.

10. The hybrid nano sorbent of claim 1, wherein the metal comprises at least one of W, Mn, Co, Cr, Mo, Mg, Ni, Zn, or any combination thereof.

11. The hybrid nano sorbent of claim 9, wherein the metal nano cluster comprises at least one of W, Co, Ni, or any combination thereof.

12. The hybrid nano sorbent of claim 1, wherein the nano-structured carbonous material is a W nano-structured carbonous material that comprises a functionalized carbon nano structure including at least an amine.

13. A hybrid nano sorbent comprising:
at least one of WO₃, ZrO₂, ZnO, MgO, MCM-41, MCM-48, MCM-22, TiO₂ or any combination thereof in an amount of from about 0 to about 50% wt.;
at least one of groups 2A, 6B, 7B, 9B, 10B, of the periodic table of elements or any combination thereof in an amount of from about 0.1 to about 9% wt.;
at least one functional group in an amount of from about 0.1 to about 3% wt.; and
remaining percent weight comprising nano-structured carbonous materials.

14. The hybrid nano sorbent of claim 13, wherein the WO₃, ZrO₂, ZnO, MgO, MCM-41, MCM-48, MCM-22, TiO₂ or any combination thereof is in an amount of from about 0 to about 25% wt; the at least one of groups 2A, 6B, 7B, 9B, 10B, of the periodic table of elements or any combination thereof is in an amount of from about 0.1 to about 5% wt.; the functional group is in an amount of from about 0.1 to about 5% wt.; and the remaining being the nano-structured carbonous material.

15. The hybrid nano sorbent of claim 14, wherein the WO₃, ZrO₂, ZnO, MgO, MCM-41, MCM-48, MCM-22, TiO₂ or any combination thereof is in an amount of about 0% wt.; the at least one of groups 2A, 6B, 7B, 9B, 10B, of the periodic table of elements or any combination thereof is in an amount of from about 0.1 to about 3% wt.; the functional group is in an amount of from about 0.1 to about 10% wt. and the remaining being nano-structured carbonous material.

16. A method for sorbing acidic compounds from gas streams comprising the placing the hybrid nano sorbent of claim 1 in a gas stream feed that includes a pressure of from about atmospheric pressure to about 10 bars, a temperature of from about 263K to about 423K in absence of oxidizing gases or oxygen and containing from about 10 to about 8000 ppm of one of H₂S, CO₂, mercapthans, SO₂, or any combination thereof;

17. The method of claim 16 further comprising regenerating the hybrid nano sorbent in a regeneration stage comprising a temperature range of from about 473 to about 573 K, and a pressure of about atmospheric pressure, and in the absence of oxidizing gases.
